(19) United States
(12) Patent Application Publication
(10) Pub. No.: US 2007/0036696 A1
(43) Pub. Date: Feb. 15, 2007

(54) Air purifier

(76) Inventors: John McEllen, Willoughby, OH (US); Christopher Brizes, Mentor, OH (US)

Correspondence Address: Gordon D. Kinder, Esq.;Renner, Otto, Boisselle & Sklar, 19th Floor, 1621 Euclid Ave., Cleveland, OH, 44115, US

(21) Appl. No.: 11/200,322

(22) Filed: Aug. 9, 2005

(51) Int. Cl. B01J 19/12

(52) U.S. Cl. 422/186.3

(57) ABSTRACT

An air purifier illustrates the invention. The air purifier includes a housing having walls defining a lower chamber and an upper chamber, and ultraviolet C lamp in the lower chamber. Air flows through an air inlet through a wall into the lower chamber. A baffle is positioned between the air inlet and the lamp blocking direct passage of radiation from the lamp to the air inlet. A dividing wall in the housing separates the upper chamber from the lower chamber, and an opening in the dividing wall allows air to pass from the lower chamber to the upper chamber. Air exits through an air outlet from the upper chamber, with the dividing wall being positioned to block direct passage of radiation from the lamp to the outlet. A fan in the upper chamber draws air in the inlet, through the lower chamber, and the opening in the wall, and directs the air to the outlet. The intensity of the lamp and the closeness of the passage of air around the lamp, together with the flow rate of the air assure that air born germs are exposed to a controlled flux of UV C radiation, which is generally selected to be fatal to the vast majority of such germs.

### FIELD OF THE INVENTION

The present invention relates to devices for purifying air.

### SUMMARY OF THE INVENTION

The present invention teaches how to make an air purifier for domestic use. An exemplary air purifier made following the teachings of the invention has two chambers. An air inlet includes a filter for particulates and leads to the first chamber which houses an ultraviolet-C (UV-C) lamp. The second chamber is connected to the first by an opening in a wall that separates them. A fan and air outlet are located in the second chamber. The inlet and outlet are baffled so that no UV-C is directly visible through any opening in either of the two chambers. The two chambers may be made at least partially of a material with a low UV-C reflectance. As a consequence of the baffling and the low internal reflectance, very limited UV-C escapes the housing.

### BRIEF DESCRIPTION OF THE DRAWINGS

FIG. 1 is a perspective illustration of an air purifier made following the teachings of the present invention.

FIG. 2 is an exploded view of the air purifier of FIG. 1 shown looking from below.

FIG. 3 is an exploded view of the air purifier of FIG. 1 viewed from above.

### DESCRIPTION OF PREFERRED EMBODIMENTS

The present invention teaches how to make an air purifier. The description that follows illustrates an embodiment of the invention, but the invention is not limited to this embodiment, as the teachings of the present invention enable those skilled in the art to create other air purifiers that follow the teachings of this patent. Accordingly, the invention is to be limited only by the claims that follow.

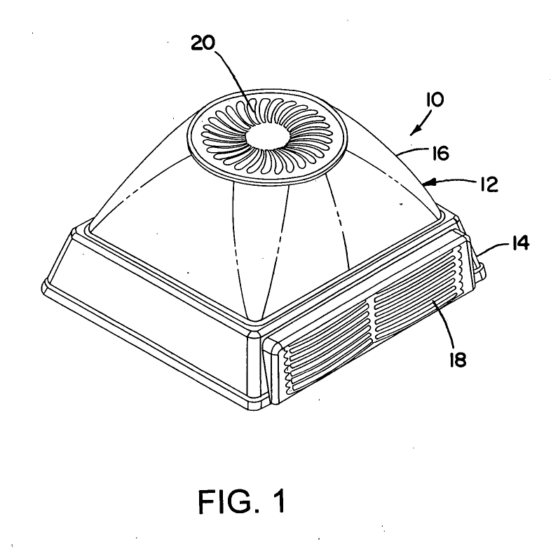

The air purifier 10 shown in FIG. 1 is constructed following the teachings of the present invention. It includes a housing 12 formed from injection molded plastic. The housing 12 has two components, a lower housing component or base 14 and an upper housing component or cap 16. A fan (not visible in FIG. 1) within the housing 12 draws air in an inlet 18 in the base 14 and expels air through an outlet 20 in the cap 16. Along the way, the air is pulled through a 0.25 micron foam particulate filter and then exposed to UV-C radiation. The UV-C radiation is sufficient to kill over 90% of common aerosolized viruses, such as influenza, rhinovirus (common cold), measles, vaccinnia (small pox surrogate) as well as aerosolized bacteria, E. coli, strep, salmonella, and staphylococcus passing through the air purifier 10.

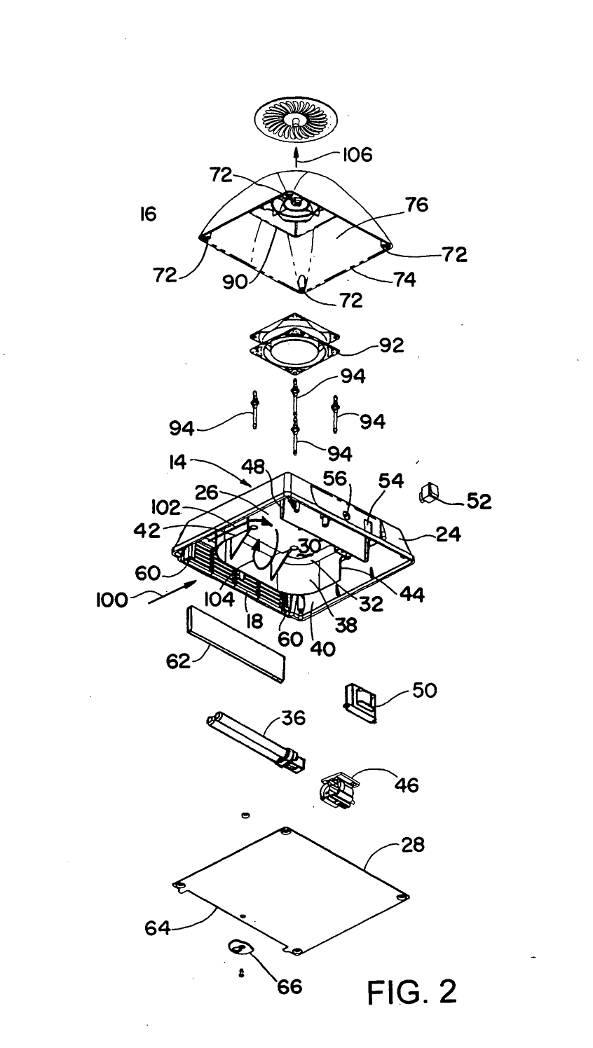

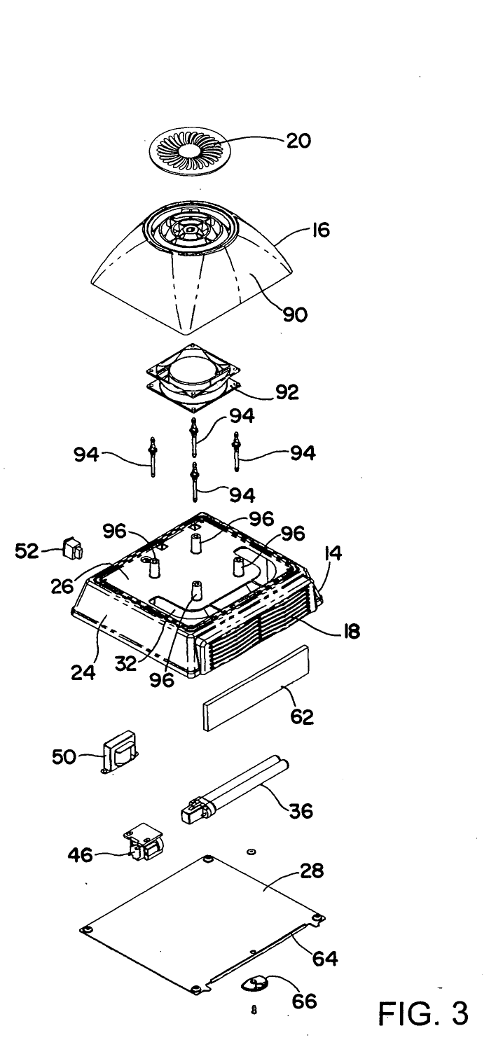

The base 14 (FIGS. 2 and 3) is defined by peripheral walls 24, a top wall 26, and a bottom plate 28. The peripheral walls 24, the top wall 26, and a bottom plate 28, form a square, frusto-pyramidal shaped lower chamber 30 that is closed except for the air inlet 18 and a passage 32 through the top wall 26. The inlet 18 is formed in one of the peripheral walls 24. The bottom plate 28 is permanently attached to the peripheral walls 24 to render the housing 12 tamper proof in ordinary use. Because UV-C radiation can be harmful to humans at excessive doses, permanently attaching the bottom plate 28 provides a consumer safeguard.

The permanent attachment of the bottom plate 28 to the base 14 can be achieved in a number of ways. Tamper resistant screws such as those with a Torx brand socket may be used. Alternatively, the base 14 may be provided with plastic studs that can pass through openings in the corners of the bottom plate 28 and then be heat deformed. Further, or in addition, a permanent adhesive may be used to secure the bottom plate to the base 14.

A UV-C lamp 36 is mounted inside the cavity defined by the base 14 and bottom plate 28. A baffle 38 divides the base 14 into a light chamber 30 and a peripheral passage 40, and it blocks direct passage of radiation from the lamp 36 through the air inlet 18. To this end, the baffle 38 extends downward from the top wall 26 of the base 14 for the full height of the peripheral walls 24, and when assembled, the bottom edge 42 of the baffle 38 rests against the bottom plate 28. The cavity is about 1.5 inches from the top of the bottom plate to the bottom of the top wall 26.

The UV-C lamp 36 is mounted in the light chamber 30. The baffle 38 extends around the entire perimeter of the chamber 30 and has only two openings, one 48 for the lamp socket 46 and one 48 for air flow. Specifically, lamp socket 46 is mounted in the peripheral passage 40 and aligned with opening 44. The other opening 48 in the baffle 38 permits air to flow from the peripheral passage 40 into the light chamber 30.

The lamp 36 is installed in the socket 46 and connected through wires (not shown) with ballast to 50 and switch 52. When power is supplied through a cord (not shown) and the switch it switched “on”, the light chamber 30 is filled with UV-C radiation. The lamp 36, comprising a pair of parallel tubes, is positioned close against the underside of the top wall 26, and just to the rear (taking the inlet 18 as the front) of the rearmost extent of the opening 32 in the top wall 26 of the base 14. As a result the lamp 36 is not visible when looking straight down on the top wall 26. As noted below the dome-shaped cap 16 has tapered walls and only a single opening in its top, and as a result any oblique view of the lamp 36 through the opening 30 is blocked. In addition, the free end of the lamp 36 is positioned just short of the baffle 38. The position of the lamp 36 and the limited amount of space around it through which the air is forced to flow control the intensity of the UV C radiation to which all of the air passing through the chamber 30 is exposed.

There are two additional openings in the walls 24 of the base 14: the opening 54 for a power switch as well as opening 56 for a power cord (not shown). These open into the peripheral passage 40 defined by the baffle 38, and so cannot be exposed directly to radiation from the lamp 36.

The base 14 includes a pair of slots 60 which receive a foam filter 62 immediately behind the inlet opening 18. The filter 62 is accessible through a notch 64 formed in the bottom plate 28. The filter 62 is held in place by a rotatable hasp 66. The filter 62 is positioned so that substantially all the air passing through the housing 12 must pass through it. The filter 62 has a pore size of no more than 0.25 microns and is effective to remove particulates larger than 0.25 microns from the air passing through it.

The top wall 26 of the base 14 includes the opening 32. This opening enables air in the light chamber 30 to travel to the interior of the cap 16. Because the baffle 38 seats against the bottom plate 28, air drawn into the peripheral passage 40 of the base 14 must flow through the light chamber 30 before passing through opening 32 into the interior of the cap 16.

The cap 16 is dome shaped and permanently connected to the base 14 and completely surrounds the opening 32. The permanent connection may be accomplished either with a suitable adhesive or with screws (not shown) that pass through the top wall 26 and into bosses 72 formed on the lower edge 74 of the cap 16. Because the screws (not shown) are accessible only from the inside of the base 14, which in turn is permanently sealed by the plate 28, once assembled, the cap 16 cannot be removed from the base 14. The cap 16 is shaped so that there is no direct path for UV C light to pass from the opening 32 through the outlet 20 to the environment.

The outlet 20 from the housing 12 is located at the top of the dome-shaped cap 16, above the passage 32 from the light chamber 30 to the upper chamber 78 defined by the interior of the cap 16. Because all direct views of the lamp 36 from above are blocked by top wall 26, no direct UV-C light can be seen through the outlet 20.

The cap 16 includes an interior skirt 90 that surrounds and extends downward from the outlet 20. The skirt 90 is shaped to mate with the fan 92. The fan 92 in this embodiment is square in plan view, and accordingly the skirt is also square. The fan 92 is mounted on studs of 94 which in turn are mounted on bosses 96 that extend upward from the top wall 32 of the base 14. Together the studs 94 and bosses 96 position the fan 92 within the skirt 90 so that air drawn into the cap 16 is expelled through the opening 18. The fan 92 is connected in parallel with the lamp 36 so that whenever one is turned on, the other is also.

When the fan 92 is on, air is drawn in the inlet 18 in the direction of arrow 100 (FIG. 2). After passing through filter 62, the air travels in the peripheral passage 40 and enters the light chamber 30 through the opening 48, as shown by arrow 102. In the light chamber 30 the air is exposed to ultraviolet-c radiation, and then it passes upward through opening 30 in the top wall 26, as shown by the arrow 104. Finally, the air is drawn up through the fan 92 and blown out the outlet 20, as shown by arrow 106.

The base and cap 14 and 16 are made of injection molded plastic. The plastic selected has a very low reflectance in the UV C band. One type of plastic that meets this criterion is polycarbonate, and in particular, a polycarbonate sold by Beyer under the trademark Makrolon. The polycarbonate is selected to be stable when exposed to UV radiation over the life expectancy of the lamp 36. As discussed above there is no direct line of sight through any opening in the housing to the lamp 36. The low reflectance of the material of which the housing is made means that there is also substantially no way for light to be reflected along an indirect path. As a result, exposure to UV C irradiance at 6 centimeters from the housing at any location is less than 0.2 microwatts per square centimeter.

The particular fan 92 and lamp 36 are chosen so that common household bacteria and viruses in the air are effectively killed when they pass through the air purifier 10, The wattages and flow rates necessary to achieve this are available to those of ordinary skill in the art. By way of example, a fan that circulates air at about 13-20 cfm (dependent on humidity), in combination with a lamp that creates at least 500 microwatts per square centimeter of UV C three inches from the lamp have proven effective in killing more than 90% of the aerosolized bacteria and viruses drawn through it. Those of ordinary skill in the art will readily recognize that, all other things being equal, if a higher air flow rate is desired, a lamp producing more UV C radiation must be used. On the other hand, if the shape of the light chamber is changed so that the air is not as closely confined about the lamp, then slower air flow rates may be required and/or a more powerful lamp may be used.

What is claimed is:

1. An air purifier comprising:
a housing having walls defining a lower chamber and an upper chamber,
an ultraviolet C lamp in the lower chamber,
an air inlet through a wall into the lower chamber,
a baffle between the air inlet and the lamp blocking direct passage of radiation from the lamp to the air inlet,
a dividing wall in the housing separating the upper chamber from the lower chamber,
an opening in the dividing wall for air to pass from the lower chamber to the upper chamber,
an air outlet from the upper chamber,
the dividing wall being positioned to block direct passage of radiation from the lamp to the outlet, and
a fan in the upper chamber drawing air in the inlet, through the lower chamber, and the opening in the wall, and directing the air to the outlet.

2. The air purifier of claim 1 where in the lower chamber of the housing is formed of an injected molded plastic component forming sides and the dividing wall and having an open bottom, and a flat plate closing the open bottom, the flat plate being permanently connected to the plastic component.

3. The air purifier of claim 1 where in the lower chamber is closed so as to be tamper proof in ordinary use.

4. The air purifier of claim 1 where in the fan moves approximately 6-8 cubic feet of air per minute and the lamp provides 500 microwatts per square centimeter of UV C three inches from the lamp thereby supplying a dose of ultraviolet C radiation effective to kill substantially all common household aerosolized bacteria and viruses passing through the lower chamber.

5. The air purifier of claim 1 further including a filter positioned between the air inlet and the lower chamber, the filter having a pore size of 0.25 microns.

6. The air purifier of claim 1 where in the upper and lower chambers are defined by polycarbonate plastic components, and the lower chamber is sealed by a permanently attached plate.

7. The air purifier of claim 1 wherein the housing includes a cap covering the dividing wall, the cap having opaque walls that are positioned to block direct passage of radiation from the lamp through the opening in the dividing wall.

8. The air purifier of claim 7 wherein the housing comprises a base with a light chamber defined by peripheral walls, a bottom plate permanently mounted to the base and a dividing wall joined to the peripheral walls, a baffle extending between the top wall and the bottom plate.
